(19) United States
(12) Patent Application Publication
(10) Pub. No.: US 2008/0083874 A1
(43) Pub. Date: Apr. 10, 2008

(54) Vacuum interface for mass spectrometer

(76) Inventors: Harry F. Prest, Santa Cruz, CA (US); James D. Foote, Sunnyvale, CA (US); Jeffrey T. Kernan, Santa Cruz, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/546,197

(22) Filed: Oct. 10, 2006

(51) Int. Cl. H01J 49/04

(52) U.S. Cl. 250/288

(57) ABSTRACT

A system includes a vacuum manifold for a mass spectrometer. The vacuum manifold defines an orifice. A vacuum valve is joined to the manifold at the orifice. A load-lock adapter is joined to the vacuum valve. A transfer line may be introduced to the mass spectrometer and withdrawn therefrom via the vacuum valve and load-lock adapter without substantially disturbing the operating environment of the mass spectrometer.

### BACKGROUND

Gas chromatography is a process by which a substance may be separated into its constituent ions or molecules. Typically, the substance is dissolved in a solvent and is injected into a long, narrow gas chromatographic capillary tube coiled within a temperature-controlled chamber. The substance and the solvent are then vaporized, and a carrier gas (e.g., Helium or Hydrogen) exerts a force upon the vaporized substances, transporting them through the capillary column. The walls of the capillary column are chemically coated with a stationary phase material. The various components of the vaporized substances interact with the stationary phase material in differing manners, meaning that they pass through the capillary column at different rates.

Gas chromatography may be used as an initial phase prior to further analysis via a mass spectrometer. Per such an arrangement, a substance to be analyzed is first separated into its constituents by a gas chromatograph. Thereafter, time-sequenced gaseous samples are delivered from the output of the gas chromatograph to the input of the mass spectrometer, i.e., into the ion source of the mass spectrometer.

Transfer of the substances from the gas chromatograph to the mass spectrometer is typically conducted via a transfer line. The transfer line extends from the gas chromatograph and penetrates the walls of the vacuum chamber of the mass spectrometer. A portion of the capillary column runs through the transfer line, and protrudes from the distal end thereof. For example, the capillary column may protrude from the transfer line by about one millimeter. The protruding tip of the capillary column enters the ion source of the mass spectrometer. Oftentimes, the capillary column must be withdrawn from the ion source, either because a new ionization technique is to be employed (thus requiring a new ion source), or because a new chromatography process is to be analyzed with the mass spectrometer.

The process of introducing or removing the capillary column into or out of the ion source is tedious. The ion source to which the capillary column mates is housed in a vacuum sealed environment, and the spectrometer operates at high temperatures-two factors that exacerbate the complexity of such introduction or removal. For example, to remove a transfer line, the mass spectrometer and the transfer line must be permitted to cool down. Then, the vacuum existing within the mass spectrometer must be broken (a pump creating the vacuum is deactivated, and a valve is opened to permit air to enter the mass spectrometer). Finally, the capillary column is withdrawn from the transfer line. At this stage, the ion source may be removed from the mass spectrometer, as well. The aforementioned steps must be conducted in reverse sequence to reintroduce a new ion source or mate a new capillary column thereto.

An opportunity exists to streamline the aforementioned processes. Such streamlining will enhance the usability of gas chromatograph/mass spectrometer systems.

### SUMMARY OF THE INVENTION

In general terms, the present invention is directed to a mass spectrometer that includes a vacuum valve interposed between a vacuum chamber manifold and a load-lock adapter.

According to one embodiment, a system includes a vacuum manifold for a mass spectrometer. The vacuum manifold defines an orifice. A vacuum valve is joined to the manifold at the orifice. A load-lock adapter is joined to the vacuum valve. The load-lock adapter has a gasket dimensioned to create a vacuum tight seal with a transfer line.

According to another embodiment, a method of removing a transfer line from a mass spectrometer includes retracting the transfer line from the mass spectrometer, so that a distal end of said transfer line clears a vacuum valve joined to the mass spectrometer. The act of retracting said transfer line occurs while maintaining a vacuum sealed environment including the mass spectrometer, the vacuum valve and the transfer line. The vacuum valve is closed, so that the vacuum sealed environment continues to include the mass spectrometer, but excludes the transfer line. Then, the transfer line is vented.

According to another embodiment, a method of introducing a transfer line to a mass spectrometer includes extending the transfer line through a load-lock adapter, so that said transfer line abuts a vacuum valve coupled to the mass spectrometer. A vacuum pump in fluid communication with said load-lock adapter is activated to create a vacuum in the load-lock adapter and the transfer line. Next, the vacuum valve is opened, and the transfer line is introduced into the mass spectrometer.

### BRIEF DESCRIPTION OF THE DRAWINGS

FIG. 1 depicts an exemplary embodiment of a mass spectrometer with a transfer line withdrawn therefrom.

FIG. 2 depicts an exemplary embodiment of a mass spectrometer with a transfer line introduced thereto.

FIG. 3A depicts an exemplary embodiment of a method of withdrawing a transfer line from a mass spectrometer.

FIG. 3B depicts an exemplary embodiment of introducing a transfer line to a mass spectrometer.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

FIG. I depicts a transfer line 100 that is withdrawn from a mass spectrometer 102. The transfer line 100 includes an outer sheath 104 and an inner sheath 106, which serve to protect and thermally insulate a capillary column (not depicted) that extends through the sheaths 104 and 106. The transfer line 100 has a proximal end 108 and a distal end 110. At its proximal end 108, the transfer line 100 couples to a gas chromatograph (not depicted) via an inlet 112. At its distal end 110, the capillary column protrudes from an outlet 114 during operation of the mass spectrometer 100, as discussed further herein, below.

The mass spectrometer 100 includes a vacuum manifold 116. Housed within the vacuum manifold 116 is an ion source 118. During operation of the mass spectrometer 100, the transfer line 100 abuts the ion source 118, and the capillary column protected within the transfer line 100 protrudes from the outlet 114 thereof, extending into the ion source 118. The ion source 118 includes an input port 120. The input port 120 exhibits a generally conical shape. The capillary column is literally funneled into its proper position within the ion source 118 by virtue of its interaction with the conical input port 120.

Time-sequenced gaseous samples of an analyte are delivered from the capillary column into the ion source 118, whereupon the aforementioned analyte samples are ionized. The ionized samples are propelled through a mass analyzer (or, e.g., filter) to an ion detector (not shown). The mass analyzer (or, e.g., filter) is energized in such a way so as to establish an electromagnetic field. The electromagnetic field has the effect of permitting, at a given point in time, only ions with a particular charge-to-mass ratio to pass through the analyzer (or, e.g., filter) to the detector. To ensure that the gaseous samples do not interact with other molecules and thereby become contaminated, the interior of the mass spectrometer 102 is evacuated by a pump, so that a vacuum exists within the vacuum manifold 116 of the mass spectrometer 102.

The vacuum manifold 116 defines an orifice 122. A vacuum (gate, ball or other) valve 124 is joined to the vacuum manifold 116 at the orifice 122. A gasket (o-ring) 126 is interposed between the vacuum (gate, ball or other) valve 124 and the vacuum manifold 116, to create a seal between the two structures. As depicted herein, the vacuum valve 124 is presented as a gate valve. This need not be the case, and the vacuum valve 124 may be embodied as other forms of valves, such as a ball valve or other form of valve for preserving a vacuum. The vacuum valve 124 is depicted and discussed as a gate valve for the sake of illustration only.

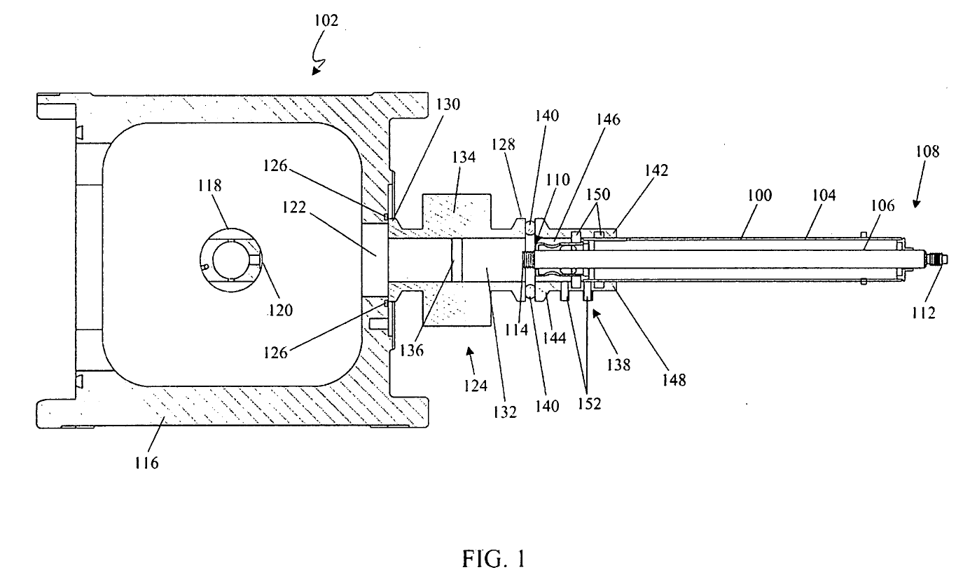

The vacuum valve 124 has an inlet end 128 and an outlet end 130 (the vacuum valve 124 may be physically symmetrical, so that its inlet end 128 and outlet end 130 are defined by use, i.e., the outlet end 130 is the end of the vacuum valve 124 that is joined to the vacuum manifold 116). A passageway 132 runs through the body 134 of the vacuum valve 124, extending from the inlet end 128 to the outlet end 130. The vacuum valve 124 also includes a plate 136. As shown in FIG. 1, the plate 136 interrupts the passageway 132. The plate 136 may be withdrawn into the body 134 of the vacuum valve 124, in which case the passageway 132 is uninterrupted. When the plate 136 interrupts the passageway 132, as shown in FIG. 1, the vacuum valve 124 is “closed,” and the inlet end 128 of the valve is not in fluid communication with the outlet end 130. On the other hand, when the plate 132 is withdrawn into the body 134 of the vacuum valve 124, the vacuum valve is “open,” and the inlet end 128 of the valve is in fluid communication with the outlet end 130. Thus, as shown in FIG. 1, assuming that the aforementioned pump is powered and actively evacuating the vacuum manifold 116, a vacuum exists in both the interior region of the vacuum manifold 116 and the outlet half 130 of the vacuum valve 124. As discussed below, a vacuum may or may not exist within the inlet half 128 of the vacuum valve 124. To move the plate 136 between its location interrupting the passage 136 and its withdrawn location within the body 134 of the vacuum valve 124, a crank (not depicted) may be provided. Physical manipulation (e.g., turning) of the crank causes the plate 136 to move between the two aforementioned positions. Also, an actuator (not depicted), such as an electropneumatic actuator may be provided to move the plate 136 between its closed and open positions.

A load-lock adapter 138 is joined to the inlet end 128 of the vacuum valve 124. A gasket 140 is interposed between the load-lock adapter 138 and the vacuum valve 124, so as to create a seal between the two structures. The load-lock adapter 138 has an inlet end 142 and an outlet end 144 (in some cases, the load-lock adapter 138 may be physically symmetrical, so that its inlet end 142 and outlet end 144 are defined by use, i.e., the outlet end 144 is the end of the load-lock adapter 138 that is joined to the vacuum valve 124). A passageway 146 runs through the body 148 of the load-lock adapter 138, extending from its inlet end 142 to its outlet end 144.

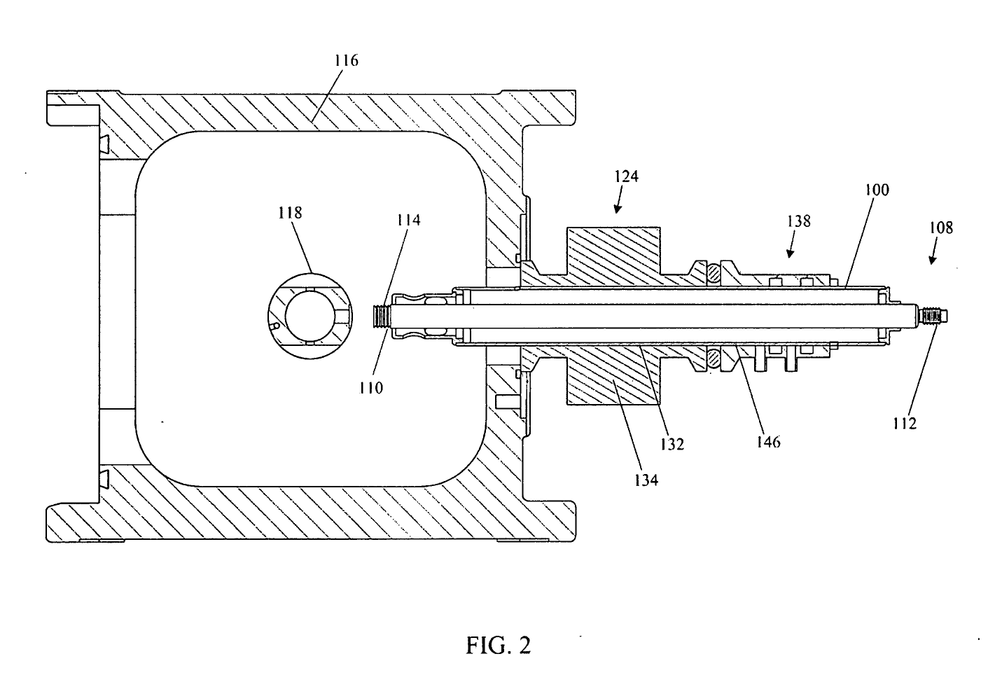

The load-lock adapter 138 includes a pair of gaskets 150. Each gasket 150 is dimensioned to form an air-tight seal with the outer sheath 104 of the transfer line 100. Although the particular embodiment depicted in FIGS. 1 and 2 depicts two such gaskets 150, the load-lock adapter 138 may, in principle, contain any number of such gaskets. On the outlet side of each gasket 150, a port 152 is provided. A pump may be coupled to the ports 152. Each port 152 thus provides fluid communication between the pump and the passageway 146 extending between the inlet 142 and outlet 144 ends of the load-lock adapter 138. Assuming that the aforementioned pump is powered and actively evacuating the passageway 146, then a vacuum is created in both the passageway 146 of the load-lock adapter 138 and the inlet half 128 of the passageway 132 extending through the vacuum valve 134.

FIG. 2 depicts the mass spectrometer 102 as it appears with the transfer line 100 introduced to the interior region of the vacuum manifold 116. As can be seen from FIG. 2, in such a configuration, the vacuum valve 124 is open, meaning that the plate (not visible in FIG. 2) is withdrawn into the body 134 of the vacuum valve 124. Thus, there exists fluid communication between the interior region of the vacuum manifold 116, the transfer line 100, the passageway 132 of the vacuum valve 124, and the passageway 146 of the load-lock adapter 138, all of which are held in a vacuum during operation of the mass spectrometer 100.

As can be seen from FIG. 2, the inlet 112 of the transfer line 100 may be threaded. According to such embodiments, a ferrule nut (not depicted) may be fastened on such threads, to create a seal at the proximal end 108 of the transfer line 100. Also, according to some embodiments, the outlet 114 of the transfer line 100 may be threaded. According to such embodiments, the ion source 118 may be fastened to the distal end 110 of the transfer line 100 by virtue of cooperation with such threads.

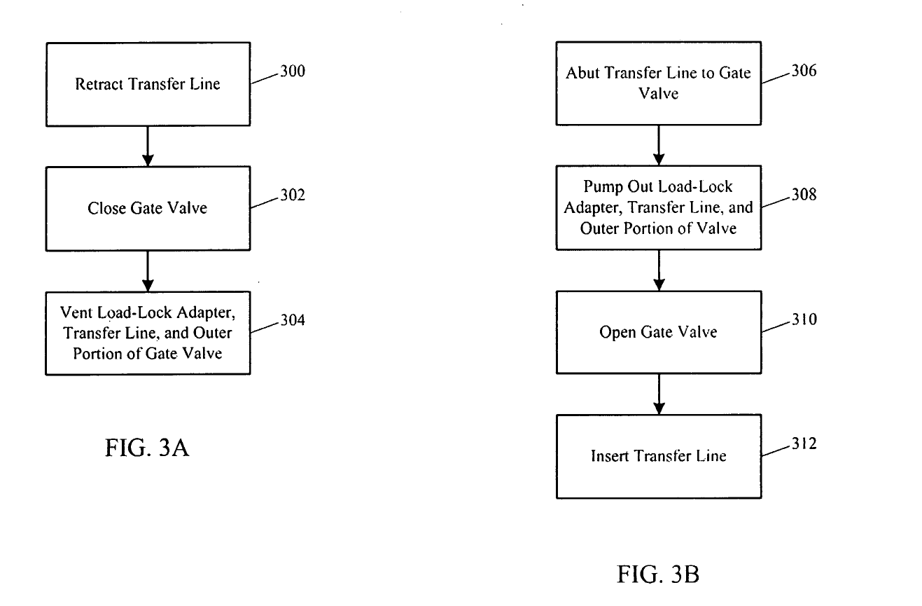

FIG. 3A depicts an exemplary embodiment of a method of withdrawing a transfer line from a mass spectrometer, such as the one depicted in FIG. 1 and 2. According to the method of FIG. 3A, the mass spectrometer 102 is initially operating, meaning that a vacuum is established within the vacuum manifold 116 and all other volumes in fluid communication therewith (the transfer line 100, etc.). Initially, the transfer line 100 is simply withdrawn from the interior of the vacuum manifold 116 (operation 300). The transfer line 100 is withdrawn so that its distal end 110 is positioned on the inlet side of the plate 136 within the vacuum valve 124 (it may be withdrawn further, as well).

Next, as shown in operation 302, the vacuum valve 124 is closed. Thus, the outlet side of the passageway 132 through the vacuum valve 124 remains in fluid communication with the interior region of the vacuum manifold 116. However, the inlet side of the passageway 132 through the vacuum valve 124, the transfer line 100, and the load-lock adapter 138 are no longer in fluid communication with the interior region of the vacuum manifold 116. Thus, the load-lock adapter 138, transfer line 100 and the inlet side of the passageway 132 through the vacuum valve 124 may be vented (operation 304), while the operating environment within the mass spectrometer is preserved, e.g., the vacuum within the vacuum manifold 116 is not disturbed, nor is the temperature of the environment within the vacuum manifold disturbed. The venting operation 304 may occur through the ports 152, for example.

According to some embodiments, the ion source 118 may by joined to the distal end 110 of the transfer line 100. Thus, removal of the transfer line 100 from the mass spectrometer 102 according to the above-described method also results in removal of the ion source 118, without disruption of the operating environment within the mass spectrometer 102.

FIG. 3B depicts an exemplary embodiment of a method of introducing a transfer line to a mass spectrometer, such as the one depicted in FIGS. 1 and 2. According to the method of FIG. 3B, the mass spectrometer 102 is initially operating, meaning that a vacuum is established within the vacuum manifold 116 and all other volumes in fluid communication therewith (the transfer line 100, etc.). Initially, as shown in operation 306, the distal end 110 of the transfer line 100 is positioned so as to abut the plate 136 in the vacuum valve 124 (the vacuum valve 124 is closed). Thereafter, the pump coupled to the ports 152 is activated, so that it evacuates the load-lock adapter 138, the transfer line 100, and the inlet end of the passageway 132 extending through the vacuum valve 124, thereby forming a vacuum in those regions (operation 308). By virtue of having created a vacuum in the aforementioned regions, the vacuum valve 124 may be opened without disturbing the operating environment within the interior region of vacuum manifold 116 (operation 310). Finally, the transfer line 100 is introduced into the interior region of the vacuum manifold 116 of the mass spectrometer 102.

According to some embodiments, the ion source 118 may by joined to the distal end 110 of the transfer line 100. Thus, introduction of the transfer line 100 to the mass spectrometer 102 according to the above-described method also results in introduction of the ion source 118, without disruption of the operating environment within the mass spectrometer 102.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A mass spectrometry system having a vacuum interface comprising:
a mass spectrometer having an ion detector and a vacuum manifold, said vacuum manifold defining an orifice;
a vacuum valve arranged to selectively seal said orifice; and
a load-lock adapter joined to said vacuum valve, said load-lock adapter having a gasket dimensioned to create a vacuum tight seal with a transfer line.

2. The system of claim 1, further comprising a transfer line extending through said lock-load adapter and vacuum valve, said transfer line having a distal end positioned in an interior region of said vacuum manifold and a proximal end adapted for operative connection to a gass chromatograph.

3. The system of claim 2 wherein an ion source is situated within said interior region of said vacuum manifold.

4. The system of claim 3, wherein:
said transfer line has a distal end that is threaded;
said ion source has a port that is threaded, said threaded port being dimensioned to receive said distal end of said transfer line, so that said threaded distal end of said transfer line and said threaded port of said ion source create a threaded joint between said ion source and said transfer line.

5. The system of claim 5, wherein said vacuum valve and said load-lock adapter are dimensioned to permit passage of said ion source.

6. The system of claim 2, further comprising a capillary column extending through the transfer line.

7. The system of claim 2, further comprising a gas chromatograph coupled to said transfer line.

8. The system of claim 1, wherein said vacuum valve comprises:
a body that defines an interior passage extending from a first end of said body to a second end of said body; and
a plate that moves between a first position, in which said plate interrupts said interior passage, and a second position, in which said plate is removed from said interior passage.

9. The system of claim 1, wherein said load-lock adapter comprises:
a body defining an interior passage; and
one or more ports for interface with a vacuum pump, said ports providing fluid communication between said interior passage and said vacuum pump.

10. The system of claim 1, further comprising a gasket interposed between said vacuum manifold and said vacuum valve.

11. A method of removing an transfer line from a mass spectrometer, said method comprising acts of:
retracting said transfer line from said mass spectrometer, so that a distal end of said transfer line clears a vacuum valve joined to said mass spectrometer, wherein said act of retracting said transfer line occurs while maintaining a vacuum sealed environment including said mass spectrometer, said vacuum valve and said transfer line;
closing said vacuum valve, so that said vacuum sealed environment continues to include said mass spectrometer, but excludes said transfer line; and
venting said transfer line.

12. The method of claim 11, wherein said transfer line is joined to an ion source, so that retracting of said transfer line from said mass spectrometer results in retraction of said ion source from said mass spectrometer.

13. The method of claim 11, wherein said act of retracting said transfer line is performed so that said transfer line is retracted into a load-lock adapter joined to said vacuum valve.

14. The method of claim 11, wherein said act of closing said vacuum valve comprises manipulation of a crank.

15. The method of claim 11, wherein said act of closing said vacuum valve is performed by an electropneumatic actuator.

16. A method of introducing a transfer line to a mass spectrometer, said method comprising acts of:
extending said transfer line through a load-lock adapter, so that said transfer line abuts a vacuum valve coupled to said mass spectrometer;
activating a vacuum pump in fluid communication with said load-lock adapter to create a vacuum in said load-lock adapter and said transfer line;
opening said vacuum valve; and
introducing said transfer line into said mass spectrometer.

17. The method of claim 16, wherein, upon introduction of said transfer line into said mass spectrometer, said transfer line is mated to an ion source situated in said mass spectrometer.

18. The method of claim 16, wherein an ion source is coupled to said transfer line, so that introduction of said transfer line into said mass spectrometer results in introduction of said ion source into said mass spectrometer.

19. The method of claim 16, wherein said act of opening said vacuum valve comprises manipulation of a crank.

20. The method of claim 11, wherein said act of opening said vacuum valve is performed by an electropneumatic actuator.
